(19) United States
(12) Patent Application Publication
(10) Pub. No.: US 2022/0277369 A1
(43) Pub. Date: Sep. 1, 2022

(54) METHOD OF ADDING GOODS AND SERVICES FROM VARIOUS SUPPLIERS TO THE ELECTRONIC SHOPPING CART WITH THE CONVERSION OF LINKS AND IDENTIFIERS INTO GOODS AND SERVICES ON THE INTERNET

(71) Applicant: OOO "Cartis", Moscow (RU)

(72) Inventors: Maxim Anatolyevich KRASAVIN, Moscow (RU); Vasilii Vasilievich KOROLKOV, Moscow (RU)

(21) Appl. No.: 17/188,098

(22) Filed: Mar. 1, 2021

(51) Int. Cl. G06Q 30/06; G06F 16/955; G06Q 30/02; G06F 16/28

(52) U.S. Cl. CPC G06Q 30/0603; G06F 16/955; G06Q 30/0635; G06Q 30/0277; G06F 16/288

(57) ABSTRACT

This invention discloses methods and systems for increasing the efficiency of acquiring goods and services from different sellers with the possibility of using a “one-click” service, achieved as a result of increasing the speed of adding goods and services to an electronic shopping cart and paying for them, as well as covering the entire spectrum of types of product information placement or service from different suppliers, adding them to one electronic shopping cart upon purchase. The invention converts hyperlinks by comparing theoretically all global links on the Internet with electronic links to the sale of goods and services and is aimed at expanding the arsenal of technical means for universal shopping carts.

### FIELD OF THE INVENTION

The invention relates to the field of information technology, in particular, to the technology of adding goods and services to an electronic cart on the Internet using the technology of URLs, internal tags, and QR codes.

### BACKGROUND OF THE INVENTION

Over the last several years, Internet-based shopping has become a significant part of commercial and social activity. All participants of such a process (e.g., merchants, marketplaces, social media, stores, payment gates and banks, delivery companies, etc.) have their own electronic tools to interact with buyers (Internet sites, mobile apps, messengers, email, text messages, or even phone calls). The problem is that, there are a lot of such participants and their electronic tools are different. By now, buyers don't have any universal electronic solution to make purchases easily, with a unified and simple interface. The present invention helps establish connections between the participants and such a class of electronic systems.

One prior art method provides a messenger application for electronic shopping associated with the simplification of processing payments when buying items on the Internet. The method includes payment confirmation in a web browser from the payment service via an API and payment confirmation from the browser through an API to the merchant's website. With this method, service components simultaneously interact with the merchants (through the API) and payment system interfaces (through their API), and also unify the order and process the payment (U.S. Pat. No. 9,922,381).

The disadvantages of this method are the comparison of the site cart APIs to the payment system APIs, the binding of the cart to suppliers' carts, the possibility of working only where there is already a cart, and also in the payment scheme: it binds through the API many payment gateways to supplier carts.

Various trading platforms are known from the prior art, for example, a method of combining data on a server (electronic trading platform), including collecting and combining information on offers of goods and services from suppliers in a central server device equipped with a means of communication with suppliers' servers and computers users of the social global information network, placing information on offers of goods and services from suppliers in a central server device and receiving requests from users to purchase goods and services, unify information on offers of goods and services from suppliers and demonstrate unified information in a user terminal system in the form of an electronic catalog located in the central server device, and they also formulate a purchase order with the subsequent redirection of the user to the server of the corresponding supplier (Russian Patent No. RU 2470363, filed Dec. 20, 2012). The specified patent describes the work of the trading platform where you can come and pick up the desired product (one supplier) by selecting offers by price, manufacturer, consumer properties, delivery dates, etc. After selection, the site is redirected to the supplier on which the payment and the transaction takes place.

The disadvantages of this method are: redirection to the server of the supplier, direct interaction of the buyer with the supplier, in addition, this method does not cover all the methods leading to the sale of goods and services and is a special case of the search system.

The technical problem to which the proposed invention is directed is the need to expand the arsenal of software and hardware products, the parameters, the characteristics of which provide the expansion of the functionality of acquiring goods or services from various suppliers without the need for the supplier to create his own online store (expanding the functional capabilities of the social-trade network), expanding the business to new channels (for example, social networks), optimizing the sale of goods or services using the Internet, in which a system has been created to provide unification service purchases from various suppliers.

### SUMMARY OF THE INVENTION

The technical result achieved by the implementation of this invention comprises expanding the arsenal of technical means for purchasing goods/services (i.e., the invention replaces, e.g., an online store, an ordinary store, a supermarket, and social networks without restrictions and registration), thereby improving security and simplifying the electronic sale and purchase of goods and services, minimizing the time and labor costs of the buyer for the purchase of goods and services, and improving the convenience of service for the buyer and efficiency for the supplier of goods or services, and the effectiveness of the acquisition of goods or services with the possibility of using the “one-click” service. The results are achieved via the increased speed of adding goods and services to the electronic cart and the increased speed of a payment made for the goods or services. The present invention covers the entire spectrum of types of publicly posted information about an offered product or service from various suppliers, providing the ability for a user to add them all into one single cart.

The specified technical result is achieved in the method by the formation of a single electronic 3^{rd} party cart comprising goods and services from various suppliers on the single Internet service, which is based on innovative principles. The necessary component for the service is the server-side-located database, which establishes relations between many commercial advertisements (via, e.g., hyperlinks and other links) relating to different suppliers, all of whom are confirmed by unique and verified hardware tokens and identifiers, the hardware tokens and identifiers corresponding to a particular supplier's products or services. One ad may correspond to many identifiers (for example, one ad for a set of items), or many ads may correspond to a single identifier (for example, many ads for a single promoted item). Such a relation also identifies additional objects and attributes including but not limited to: tags, QR codes, short-names, etc. Using this database, the cart acts as a 3^{rd} party collection of links to different ads and listings, being filled with links to the items of different suppliers. For a customer/user, the logical layout of the user interface represents an ordinary cart service, with an option to continue adding items to it regardless of the items' origins. The manner in which items become available in a certain cart may comprise any known methods, e.g., presented in the form of links (hyperlinks), or tags, or QR codes which lead to the particular goods and services, as aggregated into a single electronic cart. Integrated payment gateways (for example, API integration) provide checkout options both for online and offline payments for the cart items. Whenever it's possible, the service attempts to charge a single payment in favor of the service (followed by an automatic or manual money split) by the buyer for the acquisition of all or at least part of the goods and services, thereby without requiring user interaction with each supplier's individual checkout process. At the same time, the service provides a payment aggregator, and settles with the suppliers without disturbing the buyer. The service requires a single sign up of the buyer, and it saves payment method details for future payments to simplify the process. Also, the service provides tracking of item routing logistics using tracking information by sending identifiers provided by postal and courier services.

The claimed invention is a cart technology and an Internet service via which goods and/or services are placed into one electronic cart, in a variety of manners (e.g., links, tags, QR codes) by analogy to the clipboard or a share function of most modern apps. The invention may operate as an Internet service on its own, or it may be integrated with any application which already operates in the market.

The invention allows suppliers to place their links where they normally place their ads, e.g., social networks, social video tubes and channels, messengers, street and indoor billboards, paper ads, etc. The link may be represented by anything (e.g., tag, QR code, link), and within the database of the invention, the link is already tied to the commercial advertisement of the supplier.

The invention does not require server-side encryption (SSE) and client-side encryption (CSE). It does not need to be embedded in any site. The invention provides an independent and distinct “Buy” button, on practically any item found online, even where purchases, at first glance, seem entirely impossible. The invention provides an independent service in which, e.g., links, tags, and QR codes are registered and further mapped to internal system links rather than linking each individual site cart API to the user payment system API. The invention's single electronic cart is not associated in any manner with the suppliers' carts or checkout processes. In the payment scheme, the invention associates many payment gateways (through the system's single API) only with its single electronic cart, which is not related to any supplier checkout/cart API.

An embodiment of the claimed invention implements such a method of adding goods/services to a single electronic cart, for which the following algorithm should be completed. First, supplier's items should be registered in the system database (this may be a hyperlink, tag, QR code) that corresponds to the supplier's product/service. Second, the supplier places an ad on the Internet (i.e., on social networks, on the pages of his online store, on the blog, and theoretically anywhere, even outside the Internet, including on checks, advertising booklets, billboards, electronic advertising), that a product/service provided by the supplier may be purchased (via being added to a single electronic cart within the system) using the inventive technology. The buyer, seeing this ad, can share such an ad with any application running the inventive technology, copy the hyperlink, enter the tag into the system, scan the QR code and see in the application a copy of the supplier's advertisement, including description, photos, price, delivery terms and other details about a possible deal. The buyer can clarify the characteristics of the goods before completing the order (clothing size, colors, packaging, additions), if such details were provided by the supplier (that is, the supplier indicates in his ad a product group/service group, and not the final product/service). After adding several products or services, the buyer has a set of items from many suppliers, added from many sources, and has the way to purchase the entire cart together without interacting with each supplier directly, including for indicating delivery information, to the recipient of goods or services, payment data, etc.

Thus, when you first open the application, the cart is empty. If there is a hyperlink, tag, QR code that links to a product or service that interests a buyer, for example, from advertising, that buyer selects it, and the product/service automatically transfers to the buyer's cart.

In another case, for example, from Instagram, a buyer copies the link to the clipboard and in the widget or share function well-known among Apple-based or Android-based devices, the buyer sees a product/service that is mapped to this copied link, which is now stored in the clipboard. The buyer clicks on the copied link, thus moving the goods into the buyer's electronic cart.

Hardware token are essential for security and validation. When its known well in the Internet, the invention may offer almost anything for customers. Hardware tokens as a part of onboarding paperwork allows the system to make sure that suppliers are valid and capable to sell products and services they declare. So, only suppliers who are registered and have hardware tokens can work with the inventive technology. Hardware tokens are personally generated on the server side after a supplier passes security clearances. The token may be revoked any time and it means immediate blocking of money transfer and processing orders.

Summarizing the above, according to a preferred embodiment of the present invention, the inventive technology is a method, system, and service for adding to a single electronic cart goods and/or services from various suppliers on the Internet using internal matches (via links, tags, or QR codes) to third-party resources of suppliers. The technology adds goods and/or services by obtaining information about the link, tag, or QR code, and linking this information with the commercial advertisement registered in the database, as verified by the hardware token; for the purchase of goods and/or services, purchases from various suppliers are combined in a single electronic cart with the possibility of their further purchase by the buyer as a single purchase without mandatory interaction with each supplier (the seller is an individual or a legal entity), requiring a single registration of the buyer and his payment details on the service. Goods and/or services from a single electronic cart are purchased through a single transit to the account of the aggregation service, which provides tracking of routing logistics using tracking information services provided by postal and courier services.

### BRIEF DESCRIPTION OF THE DRAWINGS

FIG. 1 illustrates a block diagram representing an embodiment of the present invention.

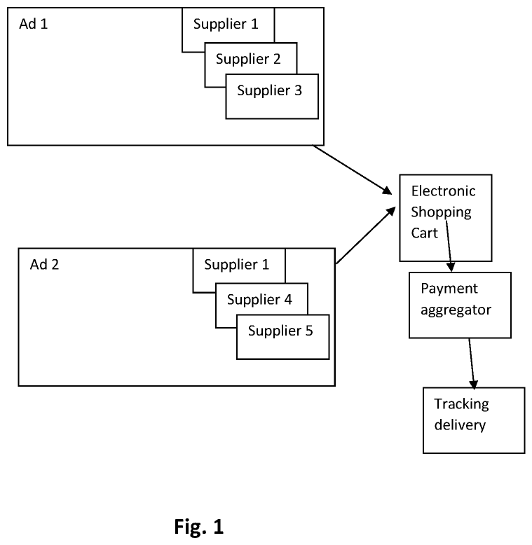

### DETAILED DESCRIPTION OF PREFERRED EMBODIMENTS

According to the invention, a supplier places a commercial advertisement for a product/service, for example, on the social network Instagram, which looks like a regular Instagram post. Every post has a unique external hyperlink or internal in-app link, which can be extracted and stored in the database of the inventive system. Inside the system database, this hyperlink or internal in-app link equals the item number within the system catalog. The same commercial advertisement (or his profile) indicates that this product/service may be purchased online utilizing the inventive technology. The supplier places one of the following objects in the specified ad: a tag registered in the database, a QR code, or neither, in which case the technology for adding to the cart will traverse through, e.g., social network links (so long as the social network supports copying links to an external clipboard).

The buyer, seeing such an ad, performs one of the following:
1) Enters a tag on a site (application) that supports the inventive technology, and, via the tag, finds the desired product/service. Each tag is unique and global in the network, it determines the supplier, the product/service, its specification, price, and conditions;
2) Scans a QR code using a device that supports the inventive technology, the principle of operation of the QR code being similar to the principle of operation of the tag (in option 1, above); or
3) Copies the link of the product/service of the supplier (i.e. seller) to the clipboard, doing so explicitly or implicitly (e.g., via the share link function of the inventive technology). The point here is that the system obtains the external link of the ad/post.

In the next step, the system attempts to convert the given link into a stored item(s) from its database. If it is successful, then the system obtains the exact supplier and the exact items which are connected to the given link. Then, items pass validation with the supplier's hardware token request, where the token must be valid, not expired or revoked, and where items and links should belong to the supplier.

As a result of the actions performed, the buyer receives a product/service that is directly related to the supplier's ad. Further, the buyer may add extra items of the same supplier or from another one, edit the cart, return later to the cart, process online and offline payments, track the delivery, and post customer's satisfaction.

In addition, the inventive technology, through the use of a theoretically unlimited number of links, can be used to theoretically compare all entities having any global links on the Internet with electronic links for the sale of goods/services placed inside the system database or even with 3^{rd} party links for goods/services with mandatory hardware token validation.

The technical problem to which the proposed invention is directed is to expand the arsenal of software and hardware products, the parameters and characteristics of which provide enhanced functionality in the selection of goods and services on the Internet using links from third-party resources (external hyperlinks) with the possibility of implementing the method of transition to purchase, in which goods and services become available for purchase to a user of the Internet using hyperlinks to these goods and services related to external resources.

The technical result achieved by the implementation of this invention is to expand the arsenal of technical means (i.e., to replace the online store, regular store, supermarket, social networks, without restrictions and required registrations) by ensuring the automatic access to goods and/or services for purchases by users of the Internet via hyperlinks to these goods and services, related to external resources. This leads to a simplification of the method of electronic sale of goods and/or services and increase sales efficiency by increasing the speed of finding goods and/or services. Furthermore, the selection and comparison of goods/services does not require the use of built-in resources of online stores, although a buyer may use the power of world search engines.

The indicated technical result is achieved in a method of converting (by hardware-software redirect) hyperlinks on the Internet to electronic links to sell goods or services on a single aggregation service of such links, which registers electronic links about goods or services and then stores them in an aggregation service database, providing the communication necessary for forwarding between the indicated electronic links and an array of arbitrary electronic links, including non-owner electronic links for goods or services, Internet hyperlinks, internal links in instant messengers and social networks, and other global electronic links available.

The inventive technology implements a method of transition to purchasing, in which goods and/or services become available for purchase to the Internet user by redirecting to these goods/services from external links of the Internet network. The search for such external links and their selection is carried out by any method available on the Internet (for example, a browser or a mobile application), and the collection of goods/services for purchase is carried out by collecting external links to the goods and services, and by correlating the collected external links with the electronic catalog derived from the database. The reference to the sale of goods and services, which in turn leads to commercial conditions, is provided by the specialized redirect service (which is the subject of the present invention), made in the form of a hardware-software structure, as described herein.

Thus, with the help of this service, one-to-one correspondence is established between external resource links and electronic links, leading to commercial advertisements of sellers about goods/services, which allows sellers and buyers to use absolutely any external links in order to find a friend, leading to an expansion of the arsenal of technical means (replacing and combining an online store, a regular store, supermarket, social networks without restrictions and registration) and simplifying and increasing the efficiency of the process of electronic sales of various goods and/or services.

As external links, any objects (e.g., webpage, image, video, sound, other media object) can be used. For example, a photo of a certain product can be posted on the Internet on any public resources: for example, the results of queries of global search engines of the class Google, Baidu, Bung, Yahoo!, DuckDuckGo, Yandex, and their analogues; specialized sites of announcements, such as Amazon, AliExpress, Yandex.Market, Avito, Yula and other sites of this class; objects on any Internet site, theoretically, including all sites of the global Internet network, including sites of competing companies.

Due to the fact that each object (or image, or video, or other media object) on the Internet has either a unique global link (URL) or other shareable identifier within its website, this shareable identifier can be used as a source of input data for redirecting to an electronic link leading to a commercial advertisement on an aggregation service compiling such advertisements. Two examples are provided below.

### Example 1

An object (image, video, other media object, post, entity) has a global link (i.e., URL). Therefore, nearly every item found online may be indexed by global search engines. For example, with a browser, any picture may be checked for its properties in order to determine its hyperlink. Any post on social networks (e.g., Instagram, Facebook, Twitter, TikTok) is shareable. Shareable means transferrable via a link which leads to the same post. Some objects (i.e. posts or profiles with privacy options) cannot be opened by someone who has no permissions for the content, however the hyperlink leading to the content is still available even to unauthorized users. The present invention stores such links and further relates those links with items/suppliers within the database.

### Example 2

An object (hidden image, hidden post, entity, etc.) doesn't have any global link. This means that this object is completely hidden from an outsider's perspective. Access permissions control such a scenario, and the object in this example doesn't support URL natively. While a user can still share the object within other apps, the user cannot open the shared link directly. The invention removes any differences between valid or non-working links; even if the link doesn't actually lead anywhere relevant, the link is still relatable to an item/supplier within the database.

Thus, hyperlinks can be links to any resources, including freely distributed ones, be publicly available or closed, valid or not valid, geographically relevant or not, etc. Further use of these links is at the discretion of the seller (the customer of this service), but in any case, the use is for commercial purposes, such as the opportunity for potential buyers to take the link and check from the hardware and software of the copyright holder of the patented service the opportunity to purchase a product or service (obviously relevant information contained in this link) on the conditions of the seller acting as the customer of the service.

The service implements such a technology in which one electronic link to a commercial ad corresponds to many (theoretically, how many are pleasing, limited only by the database size and processing time) external links. In other words, the same commercial ad becomes possible to find in several ways.

For example, there is an electronic link to a commercial ad that contains: “Bananas, 1 lb, price $0.25 available in one's home town.” External links matching this ad may be from, e.g., Google search results, Videos on YouTube about bananas, or a Walmart catalog search. The links are different and are located on different servers, but they redirect to the same electronic link (here, e.g., since Walmart is mentioned, Walmart's ad and Walmart's hardware token will be used to authorize the item) containing the seller's commercial ad. The service maintains a correspondence between a commercial ad and many external links via its database.

The claimed invention opens up a number of additional technological and marketing capabilities, including but not limited to:

1. There is an alternative to online shopping, and in the future, the method (technology) can completely replace them, making essentially all online stores global and operating under one service. If the service is sufficiently widespread, each link and every object on the Internet can be checked by customers on this service to get information about the product and service relevant to this link.

2. For search, selection, and comparison of goods/services, sellers and buyers do not need to create and use the built-in resources of online stores, and instead they can use the power of world search engines to the fullest extent by “attaching” ads to the results of search queries via the linking methods described herein. Such attaching is performed via the following specific steps:
(1) A supplier picks an item from its catalog to promote, for example, bananas.
(2) A supplier generates all the requests which might be relevant to the item. For example: ‘bananas’, ‘bananas near me’, ‘fitness’, and ‘health’. There may be many more queries, some of which are more or less relevant. The following example queries demonstrate the process.
(3) All the queries return different number of relevant results (in Google, for example): bananas—588,000,000 results; bananas near me—679,000,000 results; fitness—2,600,000,000 results; health—8,090,000,000 results.
(4) A supplier determines the most relevant results, the service thereafter placing the results (hyperlinks) into an electronic table. Duplicate results are removed. Privately-owned links are also removed. The exemplary list essentially comprises 50,345 hyperlinks. Hyperlinks may be further cleaned, which includes, e.g., removing the initial source from the hyperlink data.
(5) The 50,345 hyperlinks are then uploaded to the database of the present invention, thereby linking them to the existing item, ‘bananas’.
(6) Thus, each time a user shares with the service any copied link from a search result, the service will add the linked item (in this case, bananas) to the user's electronic cart as long as the item exists, or as long as the item may be created, within the server-side database.

3. New opportunities for sellers in the promotion of goods and services include but are not limited to: booking of most popular links in search engines, the ability to offer goods and services that are relevant to the current geographical location of customers, working with the target audience at a qualitatively new level, and using existing technologies of personalized results search engines.

The software and hardware side of the service is implemented on client-server technology, which includes three main components:
The server, which executes requests for events such as:
   registration of buyers and suppliers;
   transition to the ad of the Supplier by means of conversion of:
      external hyperlinks to third-party services;
      direct hyperlinks to system ads;
      QR codes;
      system tags.
   Placing orders and performing requests for payment processing;
   Tracking delivery of goods;
   Claim registration and customer's satisfaction management;
   Sending messages between suppliers and buyers;
   Placement of advertisements from the Supplier.
The client interface, which provides means for a user to input functions which generate requests to the server, including but not limited to:
   Web applications for the Supplier, Buyer, and service operator;
   Mobile applications for the Supplier and the Buyer.
An array of sellers' hardware tokens, each one of the sellers' hardware tokens constantly and consistently verifying a corresponding seller's identity and also that seller's set of corresponding items, said seller's set of corresponding items comprising one or more links, as described herein.

The server is responsible for centralized processing of requests from users of the technology (including buyers, sellers, and operators). The server comprises the following features:
The server may be located on any known server hardware or datacenter;
The server has the ability to scale and distribute the load between secondary servers, in order to increase service performance and ensure data security;
The server accepts requests for a specialized API, which excludes any possibility of direct or unauthorized access to the data contained within the server or any databases of the network.

The client interface allows users to access the service from any device (e.g., mobile or stationary) having Internet access and web browsing capability.

The client interface in the embodiment of a mobile application allows a user to simplify their interactions with the service by using the built-in functions of mobile devices, including but not limited to the following examples:
camera (for automatic recognition of QR codes);
clipboard (to automatically direct to the Supplier's ad in the mobile application);
widgets (to automatically display a particular supplier's item without opening the application on a mobile device);
geolocation (to automatically determine the user's location when choosing a delivery address).

A prerequisite for the operation of the service is access to the Internet from both the server and client interface components, provided by wired or wireless channels.

The service further comprises a global relational database, the database being unified across all pages, all (types of) links, and all (types of) ads. The database further comprises an interconnection (i.e. correlation) between hyperlinks to the general Internet and other links to particular ads of sellers. The database has the further ability to (optionally) convert linking at the request of the user (i.e., implementing the system as a redirect service).

The principles of the method for deploying the service are as follows:

Before the service is launched on a web or mobile application, each of the suppliers prepares one or more items. To do so, each supplier uploads and updates their catalog, which comprises information on goods and/or services provided by that supplier, including but not limited to: appearance, description, price, applicable methods of delivery to various regions, options (e.g., product sizes and colors) and other characteristics that may be useful or essential for the transaction.

For each one of the items, the supplier must associate one or more hyperlinks to the advertisements (for example, to Instagram, internal links of Telegram, VK, Facebook, any site or resource appropriate to the supplier), and/or one or more tags to the advertisement, and/or one or more QR codes to the advertisement.

When performing these steps, the service controls the uniqueness and non-intersection of records, such as but not limited to hyperlinks, advertisements, tags, and QR codes.

After the preparation of commercial advertisements via the present invention, an unambiguous relationship is established on the server between all of the following:
Third-party resources (represented as hyperlinks) and items of the suppliers;
System tags (represented with a prefix of “$”) and suppliers' items;
QR codes and suppliers' items.

The supplier may place information regarding the sale of his/her goods and/or services on any of the following platforms, corresponding to items on the service provided by the present invention:
On suppliers' websites (or webpages whose editing belongs to the supplier), the address/hyperlink of which may correspond to the links indicated above, with a note that this address can be copied to the clipboard to make a purchase through the present invention;
On any third-party sites on the Internet;
Outside the Internet (e.g., on billboards, newspapers, leaflets, in paper advertising, etc.), further comprising an internal tag or a QR code with a note that this tag can be used for shopping through the present invention.

QR codes are placed by the manufacturer or supplier of goods and/or services, and can be used as the main code for purchase or as an auxiliary code for purchases.

To make purchases, the buyer needs a smartphone or a computer with Internet access and a web browser or an installed mobile application. If using a mobile application, in order to employ all of the invention's functions, the buyer may need to activate a mode that allows the application to access the contents of the device's exchange buffer and to determine the geolocation.

Buying a product/service using the service provided by the present invention is possible in any one of the following exemplary embodiments.

In a first embodiment, the buyer, using any web browser to access a third-party application supporting the present invention, or another device connected by a wired or wireless communication channel, browses through various suppliers' commercial advertisements posted anywhere, for example, on Instagram or Facebook with the information that some items are available to purchase via the present invention. If the buyer desires the item or simply to check its price, the buyer may copy the external hyperlink to the site and paste that external hyperlink into the system by any standard/known functionality of a mobile/stationary device or third-party application. Essentially, the user must simply share the link with the system. The service, using a widget or other way of simplified visual interaction, accessing the server online, or, at the request of the buyer, checks if the given link matches one of the items of a supplier, via the database. If it matches, the buyer may continue to add the product or service to their electronic cart.

In a second embodiment, the buyer finds, somewhere on the Internet or in real life, the mention of an internal tag to the system of the present invention (represented by a value having a prefix of “$”). The buyer saves this internal tag in the application of the system (via the user interface), and if the tag matches one of the commercial advertisements of a supplier within its database, then the buyer may add the item directly to the electronic cart directly through the application.

In a third embodiment, the buyer scans a QR code using a mobile application supporting the present invention, and if it matches one of the commercial advertisements of a supplier within its database, then the item is added directly to the electronic cart.

At the same time, when buyers perform one of the above actions, any item may comprise a group of many single items (i.e. a set). For example, a ‘Spring look set’ might comprise sunglasses, a hat, a sweater, and shoes.

Using the information from sensors on the mobile device or the information provided by the buyer, and further combining this data with each item's availability options as set up by suppliers, the system determines availability of items and offers delivery options with estimated delivery times.

An electronic cart formed according to the present invention (potentially including goods and services from many suppliers) may be paid for via a single payment, by, e.g., using a bank card tied to the user's profile on the application, for which one of the payment gateways associated with the service is used (e.g., APIs of banking and non-banking organizations may be used).

After receiving confirmation from suppliers about the possibility of fulfilling their orders, funds are debited to the account of a banking or non-banking organization, and orders are completed and sent by suppliers. In the case of sending goods by postal services, the status of order fulfillment is monitored on the basis of tracking numbers provided by suppliers, for which the postal service's (or postal service aggregator's) API is used. This information is utilized by the system of the present invention to confirm the fact that suppliers have fulfilled their obligations, and it may be further tied to the implementation of automated settlements with suppliers (using the APIs of banking and non-banking organizations).

The method and technology of the present invention thus opens a number of new technological possibilities, including but not limited to the following:
1. The invention provides an alternative to shopping carts in online stores, and in the future, the technology may completely replace them, making essentially all online stores global and operating under one service.
2. The cart appears anywhere, on social networks, in advertisements, wherever the supplier can place ads and wherever the buyer/seller may be.
3. The buyer is registered only once and only in the secured system. The system provides only the information necessary regarding users for suppliers to fulfill their obligations for reasons of the necessary minimum (addresses, names, contact details, etc.). Registration of the buyers with individual suppliers is not required.
4. The technology allows for secure transactions to occur between suppliers and buyers, with the service being a guarantor of payment to the suppliers, and with the service also being a guarantor to buyers of the fulfillment of the obligations of suppliers in providing the goods/services.

Based on the above description, the present invention comprises a method, system, service, network application, or platform for forming an electronic cart of online items, comprising:
a server, said server providing application and communication services for a plurality of users,
a database, said database being a relational database, said database comprising linked data relating to supplier items available for purchase via the system, said linked data comprising hyperlinks, tags, and QR codes, said linked data corresponding to individual and non-repeating supplier items,
a user interface, said user interface providing a communication medium between any one of said plurality of users and said server and said database of the system, said user communication medium comprising means for said any one of said plurality of users to:
   add any correlating online supplier item to a universal electronic cart via shared data, said adding being provided via an application of said server,
   verify an authenticity of said correlating online supplier item, said verifying being provided via a comparison of said shared data with one or more entries within said database, and
   provide payment for an array of online supplier items, as compiled by said one of said plurality of users via said user interface, as a combined single payment to the system.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A system, comprising:
a server, said server providing application and communication services for a plurality of users,
a database, said database being a relational database, said database comprising linked data relating to supplier items available for purchase via the system, said linked data corresponding to individual and non-repeating supplier items,
a user interface, said user interface providing a communication medium between any one of said plurality of users and said server and said database of the system, said user communication medium comprising means for said any one of said plurality of users to:
add any correlating online supplier item to a universal electronic cart via said linked data, said adding being provided via an application of said server,
verify an authenticity of said correlating online supplier item, said verifying being provided via a comparison of said linked data with one or more entries within said database, and
provide payment for an array of online supplier items, as compiled by said one of said plurality of users via said user interface, as a combined single payment to the system.

2. The system of claim 1, wherein the universal cart has items from more a plurality of suppliers.

3. The system of claim 2, wherein each supplier of said plurality of suppliers is verified via one or more hardware tokens or identifiers.

4. The system of claim 1, wherein said linked data comprises a hyperlink.

5. The system of claim 1, wherein said linked data comprises a tag.

6. The system of claim 1, wherein said linked data comprises a QR code.

7. The system of claim 1, wherein said linked data comprises an advertisement.

8. The system of claim 1, wherein said linked data comprises information on social media or advertisements.

9. The system of claim 1, further comprising an integrated payment gateway.

10. The system of claim 1, further comprising a payment aggregator.

11. The system of claim 1, further comprising a tracking of item routing logistics.

12. The system of claim 1, said system operating in an absence of server-side encryption and client-side encryption.

13. The system of claim 1, wherein one of the plurality of users purchases one or more items via a single click.

14. The system of claim 1, wherein each datum of said linked data is unique and global within the system.

15. The system of claim 1, further comprising a means for posting customer satisfaction.

16. The system of claim 1, further comprising a camera.

17. The system of claim 1, further comprising a clipboard.

18. The system of claim 1, further comprising one or more widgets.

19. The system of claim 1, further comprising a geolocation feature within the user interface.

20. The system of claim 1, said database further comprising an interconnection between related supplier items.
